(19) United States
(12) Patent Application Publication
(10) Pub. No.: US 2025/0347304 A1
(43) Pub. Date: Nov. 13, 2025

(54) DEVICE FOR ATTACHING TO A PLATE-SHAPED OBJECT

(71) Applicant: FRIES Management & Investment GmbH, Sulz (AT)

(72) Inventor: Tobias WATZENEGGER, Weiler (AT)

(73) Assignee: FRIES Management & Investment GmbH, Sulz (AT)

(21) Appl. No.: 19/194,243

(22) Filed: Apr. 30, 2025

(30) Foreign Application Priority Data
May 8, 2024 (AT) A66/2024

(51) Int. Cl. F16B 5/06

(52) U.S. Cl. CPC F16B 5/065

(57) ABSTRACT

A device (1) for attaching to a plate-shaped object (2), in which the device (1) has a basic body (3), which has a recess (4) open at least toward one side for receiving a partial region of the plate-shaped object (2). The basic body (3) has a first partial body (5) and a second partial body (6), and the first partial body (5) and the second partial body (6) are mounted on each other so as to be movable relative to each other, and the recess (4) is formed between the partial bodies (5, 6).

### CROSS-REFERENCE TO RELATED APPLICATIONS

This application claims priority from Austrian Patent Application No. A66/2024, filed May 8, 2024, which is incorporated herein by reference as if fully set forth.

### TECHNICAL FIELD

The invention relates to a device for attaching to a plate-shaped object, wherein the device has a basic body, which has a recess open at least toward one side for receiving a partial region of the plate-shaped object.

Climate change and scarcity of resources are an ever more present problem for humanity today. Our consumerism leaves behind an ecological footprint and, in addition to climate protection, adaptation to the inevitable consequences of climate change is becoming increasingly important. In order to keep the ecological footprint as small as possible, care should be taken when choosing packaging to ensure that it uses as little material as possible and still provides an appropriate protective function. Space and material are saved by well thought-out storage, warehousing and transport of plate-shaped objects. In goods logistics, one of the most important load carriers is the classic wooden pallet. For transport to the customer, plate-shaped objects are usually individually packaged in cartons and stored one above another on wooden pallets. In order to ensure safe transport and to prevent the wooden pallet with the plate-shaped objects from slipping, a tensioning strap is connected to the pallet. Additional packaging material has to be used for the return transport. A major disadvantage of the packaging material is that cardboard, in particular, is very sensitive to moisture, and therefore the protective function is also minimized. Due to the problems described, new methods therefore have to be developed in order to be able to satisfactorily stack, hold, store and transport plate-shaped objects.

In principle, the problem of the device for attaching to a plate-shaped object, and the stacking, storage and transport that are thus made possible, is, however, not only limited to goods logistics, but also to other areas, for example to private purposes, where stacking, storing and transporting plate-shaped objects may likewise be necessary.

EP 2 230 157 B1 of the type in question discloses a stacking aid consisting of a basic body with an opening in which a buffer structure is located, wherein a rectangular product can be held in the opening and thus via the buffer structure. The rectangular product is held here via the geometry, which tapers toward the depth of the opening. However, the buffer structure of the stacking aid may become detached from the basic body and may thus allow the rectangular product to drop out of the stacking aid onto the ground. Another problem of the present invention is that the buffer structure has to have precisely the width of the opening, which corresponds to the narrowest side length of the rectangular product, so that the rectangular product can be held. A suitable buffer structure therefore has to be produced in advance.

DE 10 2008 012 774 A1 discloses a holding system for the horizontal or vertical stacking of plates, preferably photovoltaic panels. The holding system can be attached to the edges of the plates and consists of molded parts which are connectable to one another by a mechanical toothing and locking to the module frame to form stable vertical columns or horizontal rails. The holding system is fastened to the plate at the edge via the engagement element. It is possible to position the holding systems in one another via the pins.

### SUMMARY

It is the object of the invention to improve a device of the type mentioned at the beginning in such a way that it can be reliably used for plate-shaped objects of different thicknesses, e.g., for stacking on top of one another.

To this end, the invention provides, starting from a device of the type mentioned at the beginning, that the basic body has a first partial body and a second partial body, wherein the first partial body and the second partial body are mounted on each other so as to be movable relative to each other, the recess being formed between the partial bodies.

Owing to the movability of the two partial bodies relative to each other, the dimension or, in other words, the opening width of the recess can be adapted to the individual thickness of the respective plate-shaped object which is intended to be received in the recess. This is possible rapidly and easily with the invention. This can be used by the user for stacking but also in other ways, for example for safe storage and/or holding and/or transporting and/or carrying of the plate-shaped objects and/or also for protecting the corner regions and/or edge regions of the plate-shaped objects from damage.

For the sake of completeness, it is pointed out that, over the course of the description of this invention, the numerals used, such as one, two, three and the like, in principle describe only the existing minimum quantity of a feature of the device according to the invention. Of course, individual features or components of the device may also be present in greater numbers. In this context, the numeral word one, for example, should be understood as meaning at least one, etc.

In the invention, the first partial body and the second partial body, as stated, are mounted on each other so as to be movable relative to each other, the recess being formed between the partial bodies. In this connection, it is important to mention that the invention may include various possibilities for realizing this movability. This can be realized, for example, by the two partial bodies being mounted on each other so as to be displaceable relative to each other. Instead of or in addition to this displaceability, however, it may also be provided that the partial bodies are rotatably mounted on each other so as to be rotatable relative to each other. Preferably, it is at any rate provided that the two partial bodies can move relative to each other away from each other and also relative to each other toward each other. Depending on the type of project, the two partial bodies may also be movable in a plurality of directions.

It is also possible for one of the two partial bodies to be replaceable at any time in the event of defects. The material of which the two partial bodies are made is advantageously chosen in such a way that the surface of the recess does not scratch and/or in any other way impair or even destroy the plate-shaped object.

In preferred embodiments, it is provided that the device has an elastic element, wherein the two partial bodies are elastically preloaded toward each other by the elastic element in order to clamp the plate-shaped object in the recess. By means of the elastic element, the plate-shaped object can be clamped between the partial bodies. The device is then held on the plate-shaped object by clamping. On the one hand, this enables a secure and reliable fastening of the device to the plate-shaped object. On the other hand, the elastic element also allows easy and rapid assembly and removal of the device on and from the plate-shaped object. The opening width of the recess can therefore be adjustable against the elasticity. As an alternative or in addition to the elastic element, the two partial bodies could also be connected to each other, however, by means of a screw connection of the device, with the partial bodies being able to be clamped by means of the screw connection to the plate-shaped object, which is received in the recess. As an alternative thereto, however, it would also be possible in principle for the two partial bodies to be attached by screwing, adhesive bonding or the like to the plate-shaped object, which is received in the recess.

In the present invention, the elastic element can be compressible by moving the partial bodies away from each other. The elastic element can be a helical spring. In preferred exemplary embodiments, the present device has a compression spring. It is conceivable for the compression spring to be, for example, a conically or cylindrically shaped compression spring. The term compressible can also be described in such a way that the compression spring is pressed together or compressed under an external action of force. As soon as the action of force is removed, the spring expands again. As an alternative to the compression spring, however, it is also conceivable, in a corresponding embodiment, for a tension spring to be used in a further exemplary embodiment.

The elastic element can be a permanent component of the device. It can also be releasable, preferably non-destructively, and thus exchangeable and/or replaceable by another type of elastic element, for example in the event of defects.

A part of the device, in particular the basic body, can be designed in such a way that the recess, which is formed between the two partial bodies, is shaped for receiving a corner region of the plate-shaped object. By the plate-shaped object being received via its corner region, it is also possible for said object to be protected from damage. The invention also includes the possibility that the basic body is designed in such a way that it can receive the plate-shaped object with its longitudinal edges or transverse edges in the recess. The longitudinal edges of the plate-shaped object may also be referred to as its longitudinal sides and its transverse edges may also be referred to as transverse sides. Generally speaking, however, the recess can be differently shaped in such a way that it can receive differently shaped regions of plate-shaped objects, i.e., for example, even rounded corners or edges or the like.

A preferred embodiment of the present invention provides that the first partial body has a column having a first contact shoulder for the elastic element and the second partial body has a sleeve having a second contact shoulder for the elastic element. The device can be configured in such a way that the column can be located inside the sleeve.

In a preferred variant, it is provided that the column has an elongate column element and a cover attached releasably to the column element, and the first contact shoulder is formed on the cover. The cover can be releasable at any time, preferably non-destructively and therefore so that it may be reusable. Exchange in the event of defects is therefore conceivable. In addition to the releasable fastening of the cover, it is also possible, however, for the cover to be fastened permanently to the second partial body. In other words, it is fastened non-releasably. The cover preferably has a round shape. However, an alternative to the round cover is possible, for example, in that the cover has an angular and/or oval shape.

In the most preferred variant, it is provided that the elastic element is arranged in an intermediate space between the column and the sleeve. It can be provided that the column and the sleeve and the elastic element have a coaxial arrangement. The sleeve and column can be positioned in such a way that the column is located inside the sleeve.

It is preferably provided that the first partial body has a first guide element and the second partial body has a second guide element. These guide elements can be used for guiding the partial bodies toward each other and away from each other in a relative movement. The guide element can thus allow a guided movement toward and away from each other. The first guide element and the second guide element can be shaped in such a way that their corners can be flattened or rounded. The guide elements can be located on one side of the respective partial body and/or also between two column elements and/or sleeve elements. Another possibility is that the respective guide element can be located on that side of the respective partial body which does not have a column element and/or sleeve element.

In the present invention, it is also conceivable that the first partial body has a first form-fitting element on a side facing away from the recess and the second partial body has a second form-fitting element on a side facing away from the recess. In the device, it is conceivable that the elastic element is preloaded in a direction of action, and the first form-fitting element and the second form-fitting element are designed for a form fit in a direction transversely or orthogonally to the direction of action.

The term transversely refers to angles from 1° to 89°, in particular from 70° to 89°. The term orthogonally describes an angle of 90°.

It is possible that the first partial body and/or the second partial body has and/or have, for example on an outer side, a strap receptacle for attaching a tensioning strap. It is therefore conceivable that only the first partial body or only the second partial body or both partial bodies have such a strap receptacle for attaching a tensioning strap. There are two options in respect of attaching a tensioning strap. The tensioning strap can be permanently connected to the first and/or second partial body via a strap receptacle. Another possibility is, however, also that the tensioning strap is releasable, preferably non-destructively, at any time. The tensioning strap can be attached to the two partial bodies as additional protection against slipping during transport of the plate-shaped objects. However, it is also possible to use a strap to carry and/or lift the plate-shaped objects.

By means of the tensioning straps, it is also possible for the plate-shaped objects to be stored and/or held and/or stacked even on an inclined plane.

In addition to the device, the invention also relates to a stack having at least two plate-shaped objects stacked on top of one another, wherein the plate-shaped objects are each received, preferably by their longitudinal edges and/or corner regions, in recesses of devices according to the invention, wherein the plate-shaped objects are stacked on top of one another by means of the devices, and the respectively adjacent plate-shaped objects in the stack are spaced from one another, preferably throughout. In other words, this therefore means that the plate-shaped objects are in contact exclusively via the devices.

In addition to the device per se and the stack, the invention also relates to the use of devices according to the invention, wherein plate-shaped objects are received, preferably by their longitudinal edges and/or corner regions, in recesses of the devices, and the plate-shaped objects are stacked on top of one another by means of the devices, wherein respectively adjacent devices in the stack rest on one another and the respectively adjacent plate-shaped objects in the stack are spaced from one another, preferably throughout.

### BRIEF DESCRIPTION OF THE DRAWINGS

Further features and details of preferred embodiments of the invention are explained by way of example in the following description of the figures. In the figures:

FIG. 1: shows an illustration of a stack of plate-shaped objects stacked on top of one another by means of the devices;

FIG. 2: shows an illustration of a possibility of fastening the device to a plate-shaped object;

FIG. 3: shows an illustration for stacking two plate-shaped objects on top of each other by means of the devices;

FIG. 4: shows an illustration of a device according to the invention used in FIGS. 1 to 3 in the maximally open state;

FIG. 5: shows an illustration of the outer side of the device from FIG. 4 in the maximally open state;

FIG. 6: shows an illustration of the device from FIG. 4 in the maximally closed state;

FIG. 7: shows an exploded illustration of the device from FIG. 4; and

FIG. 8: shows a sectional illustration of the device from FIG. 4.

### DETAILED DESCRIPTION

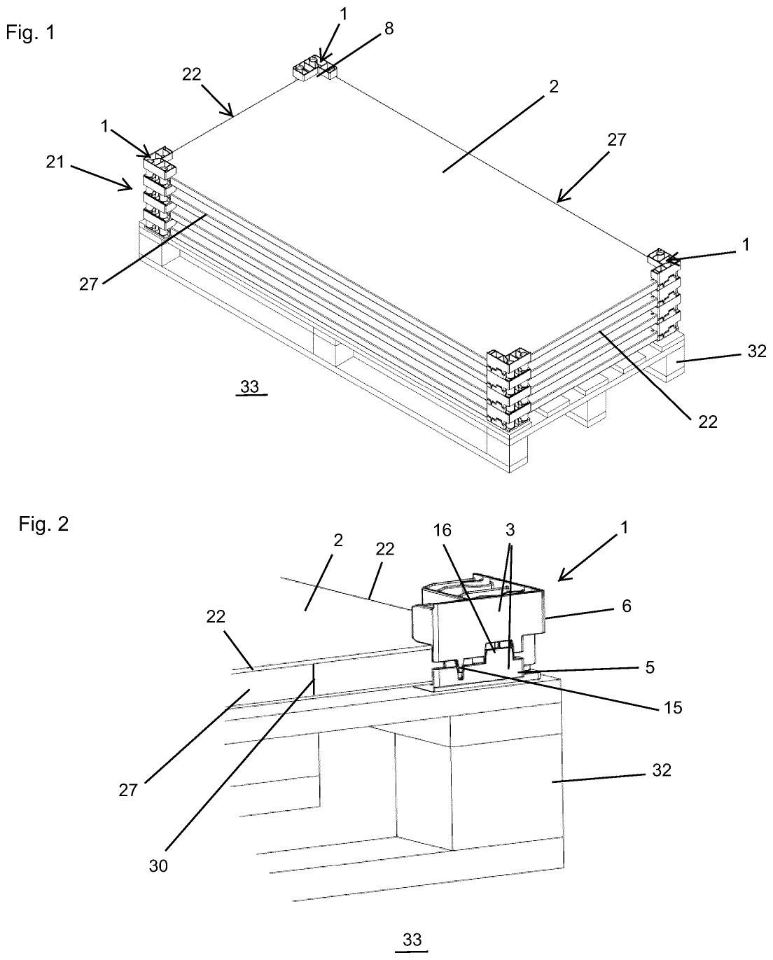

FIG. 1 shows, by way of example, four plate-shaped objects 2 stacked on top of one another to form a stack 21. The stack 21, which is illustrated in perspective in FIG. 1, comprises a plurality of devices 1 according to the invention and a plurality of plate-shaped objects 2. The plate-shaped objects 2 are stacked on top of one another congruently or flush, in each case with the interposition of the devices 1. The plate-shaped objects 2 are stored here by way of example on a pallet 32. The respectively adjacent plate-shaped objects 2 are spaced from one another, preferably throughout, and are in contact exclusively indirectly via the devices 1. In this example, the devices 1 are designed for receiving a respective corner region 8 of the plate-shaped objects 2 and are arranged accordingly in the corner regions 8 of the plate-shaped objects 2. It is also conceivable that the respective devices 1 are not arranged at the corner regions 8 of the plate-shaped objects 2, but are alternatively also located at their longitudinal edges 22 and/or transverse edges 27.

FIG. 2 shows how the device 1 is fastened to the corner region 8 of the plate-shaped object 2. It is also evident that the device 1 comprises a basic body 3, which has a first partial body 5 and a second partial body 6. FIG. 2 shows that the first partial body 5 has a first guide element 15 and the second partial body 6 has a second guide element 16.

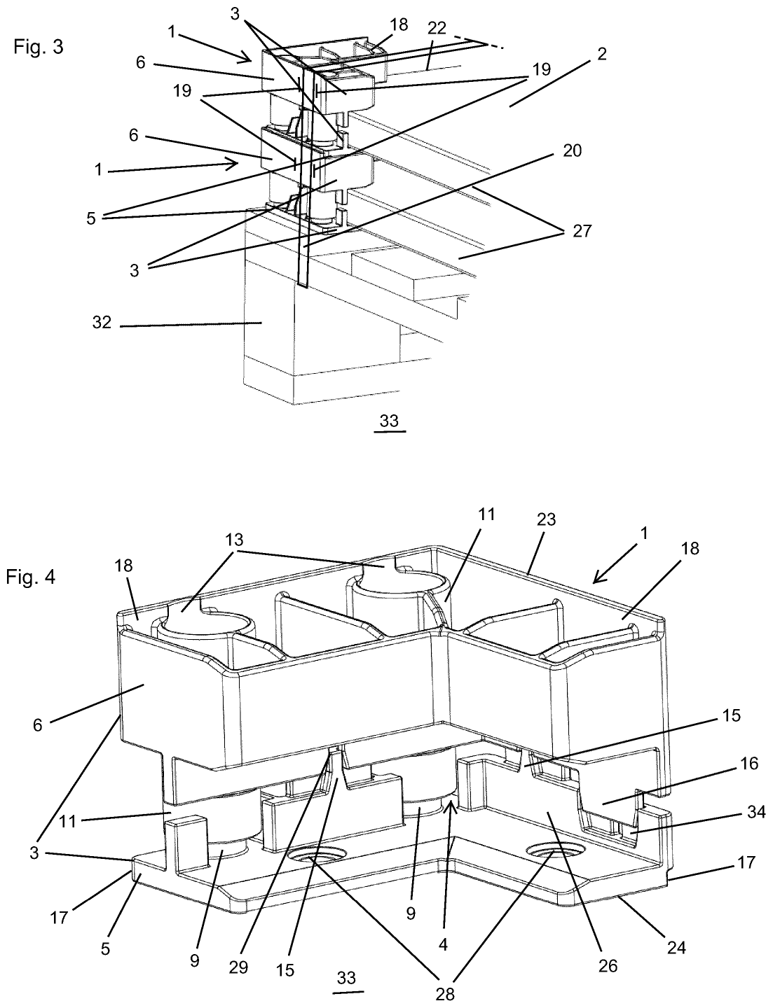

FIG. 3 shows two devices 1 and thus two basic bodies 3. Similarly, the stacking of two corresponding plate-shaped objects 2 on top of each other is shown by way of example. This is, of course, only the smallest number of plate-shaped objects 2 which can be stacked on top of one another. It is evident in FIG. 3 that the plate-shaped objects 2 are spaced from one another throughout and are only indirectly in contact via the device 1. The device 1 is attached to the corner regions 8 of the plate-shaped object 2. The devices 1 are stored on a pallet 32. However, it is also conceivable for the devices 1 and thus the plate-shaped objects 2 to be placed on another substrate 33, for example on the ground. It is also evident in FIG. 3 that each basic body 3 has a first partial body 5 and a second partial body 6.

FIG. 4 shows the device 1 detached from the plate-shaped object 2 in a detailed illustration of the basic body 3 and of the first partial body 5 and second partial body 6.

In FIG. 4, it is shown that two columns 9 are arranged on the first partial body 5 and two sleeves 11 are correspondingly arranged on the second partial body 6. The columns 9 can be received, as also realized here, by the respective sleeve 11 or can extend in each case into the latter.

It is also evident in FIG. 4 that the second partial body 6 has a second form-fitting element 18 and the first partial body 5 has a first form-fitting element 17. It is preferably provided, as also realized here, that when two plate-shaped objects 2 are stacked on top of each other by means of the devices 1, the underside 24 of the first partial body 5 is placed onto the top side 23 of the second partial body 6. When the first partial body 5 of a first device 1 is stacked on the second partial body 6 of a second device 1, the first form-fitting element 17 on the first partial body 5 forms a form fit with the second form-fitting element 18 on the second partial body 6, as a result of which slipping of the two devices 1, which are stacked on top of each other, and thus also of the plate-shaped objects 2, which are stacked on top of each other, relative to each other is prevented, also see FIG. 3.

FIG. 4 shows the recess 4 of the device 1, by means of which the plate- shaped object 2 can be received. The recess 4 has an angular shape in FIG. 4, here specifically a shape at a right angle. However, it is also conceivable for the recess 4 to be able to be elongate and to be able to receive the plate-shaped object 2 via its longitudinal edge 22 or transverse edge 27. It is also conceivable for the two partial bodies 5, 6 and/or for one of the two partial bodies 5, 6, for example, also to be able to have a triangular and/or round shape, if the plate-shaped objects 2 are correspondingly shaped at the point at which the respective device 1 is intended to be arranged.

In this connection, it is mentioned that the term longitudinal edge 22 usually describes the longer of the two edges of the plate-shaped object 2 and the term transverse edge 27 usually describes the shorter of the two sides. However, it is also possible for the longitudinal and transverse edges 22 and 27 to be identical in length.

The first guide element 15 of the first partial body 5 and the second guide element 16 of the second partial body 6 are shown in FIG. 4. They enable the two partial bodies 5, 6 to be guided toward each other or away from each other along an axis, particularly preferably parallel to the direction of action 31 of the elastic element 7, which is also explained further below.

It is evident in FIG. 4 that the first guide element 15 has a conical shape with a flattened tip. As an alternative to the conical shape with a flattened tip, however, it is equally conceivable, for example, for the first guide element 15 to have a conically rounded tip. It may also be provided that the first guide element 15 is elongate and is in the form of a cuboid or cylinder or prism. This same freedom in design is also available for the second guide element 16.

The two partial bodies 5 and 6 each have receiving recesses 29 and 34, in which the guide elements 15 and 16 of the respective other partial body 5 and 6 are received and guided.

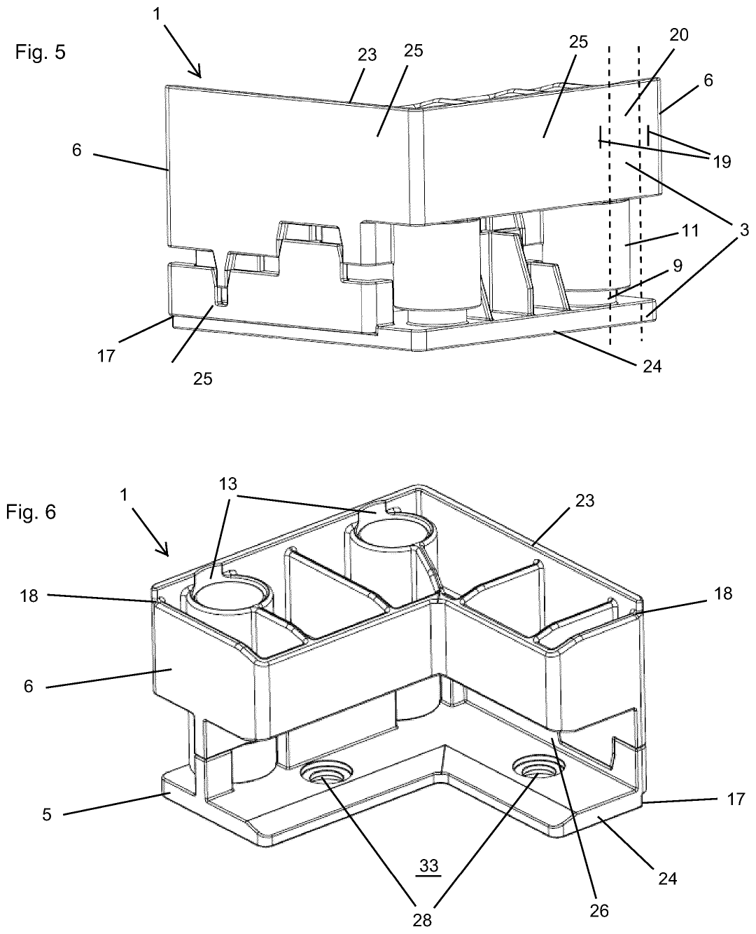

FIG. 5 shows the outer sides 25 of the device 1 and of the first partial body 5 and second partial body 6. The outer sides 25 are the sides opposite the inner sides 26 and are thus not in contact with the longitudinal edge 22 or the transverse edge 27 of the plate-shaped object 2.

FIG. 5 furthermore shows that a strap receptacle 19 can be arranged in each case on the outer side 25 of the device 1, here on the second partial body 6. In this example, the strap receptacle 19, as shown in FIG. 5, has a slot-shaped design, by means of which the tensioning strap 20 can be attached to the device 1 and secured against slipping. The tensioning strap 20 is preferably in the form of a belt, as shown in FIG. 5. The material of the tensioning strap 20 is preferably selected in such a way that it is elastic and/or is not quickly damaged and/or is easy to clean. Tensioning straps 20 made of metal are also possible. The tensioning strap 20 can preferably be adjusted in terms of length. In other words, it is therefore possible for the user to be able to adjust the length of the tensioning strap 20 individually depending on the thickness 30 of the plate-shaped objects 2. FIG. 3 illustrates, by way of example, how with a tensioning strap 20, which is attached and guided in the strap receptacles 19, the devices 1 and the plate-shaped objects 2 held therein can be additionally secured against slipping.

FIG. 6 shows the device 1 in a position in which the recess 4 for receiving the plate-shaped object 2 has the smallest opening width.

It can be seen in FIG. 6 that a cover 13 is arranged on each of the columns 9.

FIG. 6 shows a receiving opening 28 for a screw connection, preferably bore, on the first partial body 5. It is conceivable for the first partial body 5 to be able to be fastened to the plate-shaped object 2, or else to a pallet 32 or to a substrate 33 via the receiving opening 28 by means of a screw.

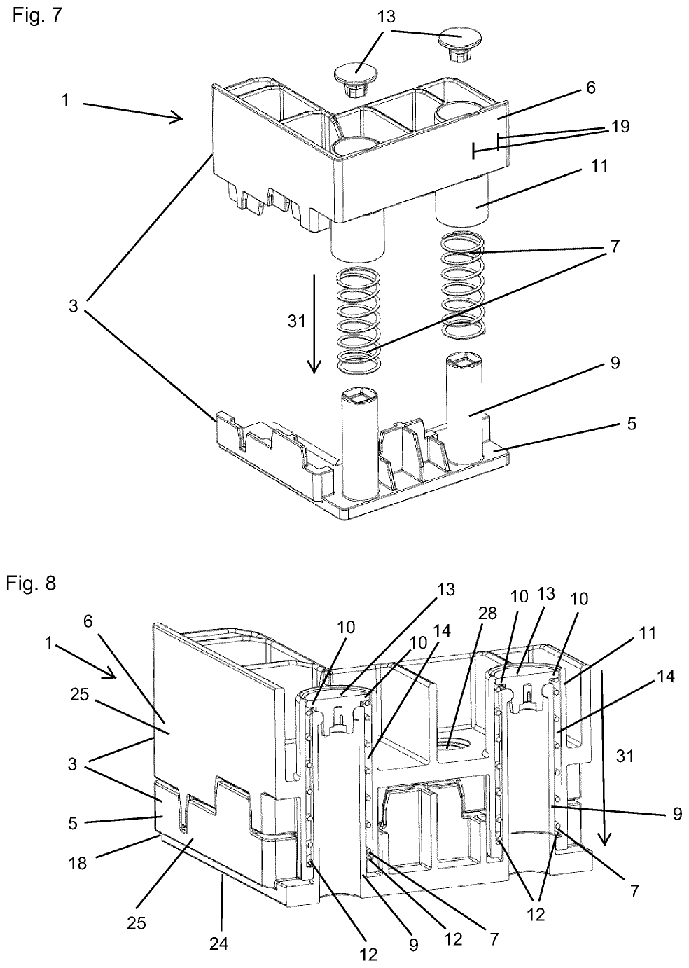

FIG. 7 shows the device 1 in an exploded illustration and thus also the elastic element 7. In this example, the elastic element 7 is in the form here of a helical spring. In the most preferred case, the helical spring is a compression spring but, in an appropriate modification, it may also be a tension spring.

The two elastic elements 7 present in this exemplary embodiment each act in a direction of action 31 in which they preload the two partial bodies 5 and 6 toward each other. This means that the elastic elements 7 act in such a way that they reduce the opening width of the recess 4, as a result of which a plate-shaped object 2 is clamped in the recess 4 between the two partial bodies 5 and 6.

FIG. 8 shows where the elastic elements 7 are preferably arranged. In this exemplary embodiment, the elastic elements 7 are each arranged in an intermediate space 14 between the sleeve 11 and the column 9. A removable cover 13 is in each case fastened at the upper end of the column 9, i.e., at the end facing away from the first partial body 5, the cover in each case forming the first contact shoulder 10 for the elastic element 7. On the opposite side, the respective elastic element 7 presses in the direction of action 31 onto the respective contact shoulder 12, which is in each case formed at the end of the respective sleeve 12. The releasable fastening of the respective cover 13 to the respective column 6 enables easy assembly of the respective elastic element 7.

FIG. 8 also shows that a receiving opening 28 for a screw connection, preferably bore, can also be located in the second partial body 6. Via said receiving opening 28, the second partial body 6 can be screwed to the plate-shaped object 2 or to a pallet 32 or to a substrate 33.

### KEY TO THE REFERENCE SIGNS

1 Device
2 Plate-shaped object
3 Basic body
4 Recess
5 First partial body
6 Second partial body
7 Elastic element
8 Corner region
9 Column
10 First contact shoulder
11 Sleeve
12 Second contact shoulder
13 Cover
14 Intermediate space
15 First guide element
16 Second guide element
17 First form-fitting element
18 Second form-fitting element
19 Strap receptacle
20 Tensioning strap
21 Stack
22 Longitudinal edge
23 Top side
24 Underside
25 Outer side
26 Inner side
27 Transverse edge
28 Receiving opening
29 Receiving recess
30 Thickness
31 Direction of action
32 Pallet
33 Substrate
34 Receiving recess

1. A device for attaching to a plate-shaped object, the device comprising:
a basic body which has a recess open at least toward one side for receiving a partial region of the plate-shaped object; and
the basic body including a first partial body and a second partial body, the first partial body and the second partial body are mounted on each other so as to be movable relative to each other, and the recess is formed between the first and second partial bodies.

2. The device as claimed in claim 1, further comprising an elastic element, and the two partial bodies are elastically preloaded toward each other by the elastic element in order to clamp the plate-shaped object in the recess.

3. The device as claimed in claim 2, wherein the elastic element is a helical spring.

4. The device as claimed in claim 2, wherein the elastic element is compressible by moving the partial bodies away from each other.

5. The device as claimed in claim 1, wherein the recess is shaped for receiving a corner region of the plate-shaped object.

6. The device as claimed in claim 2, wherein the first partial body has a column having a first contact shoulder for the elastic element and the second partial body has a sleeve having a second contact shoulder for the elastic element.

7. The device as claimed in claim 6, wherein the column has an elongate column element and a cover attached releasably to the column element, and the first contact shoulder is formed on the cover.

8. The device as claimed in claim 6, wherein the elastic element is arranged in an intermediate space between the column and the sleeve.

9. The device as claimed in claim 1, wherein the first partial body has a first guide element and the second partial body has a second guide element for guiding the partial bodies toward each other and away from each other during a relative movement.

10. The device as claimed in claim 1, wherein the first partial body has a first form-fitting element on a side facing away from the recess and the second partial body has a second form-fitting element on a side facing away from the recess.

11. The device as claimed in claim 10, further comprising an elastic element, and the two partial bodies are elastically preloaded toward each other by the elastic element in order to clamp the plate-shaped object in the recess, the elastic element is preloaded in a direction of action, and the first form-fitting element and the second form-fitting element are shaped for a form fit with one another in a direction transversely or orthogonally to the direction of action.

12. The device as claimed in claim 1, wherein at least one of the first partial body or the second partial body has a strap receptacle for attaching a tensioning strap.

13. A stack, comprising:
at least two plate-shaped objects stacked on top of one another, the plate-shaped objects are each received in recesses of the devices as claimed in claim 1; and
the plate-shaped objects are stacked on top of one another via the devices, and respectively adjacent ones of the at least two plate-shaped objects in the stack are spaced from one another by the devices.

14. The stack of claim 13, wherein at least one of longitudinal edges or corner regions of the plat-shaped objects are received in the recesses of the devices.

15. A method of stacking plate-shaped objects, the method comprising:
providing a plurality of the devices as claimed in claim 1;
placing the plate-shaped objects such that longitudinal edges and/or corner regions thereof are received in the recesses of the devices;
stacking the plate-shaped objects on top of one another to forma stack such that respectively adjacent ones of the devices in the stack rest on one another and the respectively adjacent plate-shaped objects in the stack are spaced from one another.
